(19) United States
(12) Patent Application Publication
(10) Pub. No.: US 2025/0112687 A1
(43) Pub. Date: Apr. 3, 2025

(54) DEVICES, METHODS, AND SYSTEMS FOR MULTI-SATELLITE DIVERSITY COMBINING WITH AN OFDMA AIR INTERFACE

(71) Applicant: ATC Technologies, LLC, Reston, VA (US)

(72) Inventors: Santanu Dutta, Vienna, VA (US); Dunmin Zheng, Vienna, VA (US)

(21) Appl. No.: 18/899,301

(22) Filed: Sep. 27, 2024

Related U.S. Application Data
(60) Provisional application No. 63/586,025, filed on Sep. 28, 2023.

(51) Int. Cl. H04B 7/185; H04L 1/1812

(52) U.S. Cl. CPC H04B 7/18513; H04B 7/18534; H04L 1/1819

(57) ABSTRACT

A base station including an electronic processor configured to: receive a first signal from a primary satellite, the first signal including a plurality of raw signals from a first user equipment camped on a downlink of the primary satellite; receive a second signal from a diversity satellite, the second signal including at least one of the plurality of raw signals from the first user equipment; store, in a signal sample memory, a copy of the first signal and a copy of the second signal; estimate a bipolar delay for the user equipment; synchronize the copy of the first signal and the copy of the second signal by applying the bipolar delay to the copy of the second signal; and combine the synchronized copies of the first and second signals to generate a plurality of synchronized raw signals for the first user equipment.

### CROSS-REFERENCE TO RELATED APPLICATION

This application claims the benefit of U.S. Provisional Application No. 63/586,025, filed on Sep. 28, 2023, the entire contents of which is herein incorporated by reference.

### FIELD

The present disclosure relates generally to satellite communication systems. More specifically, the present disclosure relates to a satellite communication system with multi-satellite diversity combining while utilizing an Orthogonal Frequency Division Multiple Access (OFDMA) air interface.

### SUMMARY

Multi-satellite diversity combining has many advantages. One particular advantage is increasing the uplink sensitivity (commonly characterized by antenna receive gain/noise temperature (G/T)) by coherently combining several copies of the uplink signal, received via diverse satellite paths.

Achieving coherent combining of the uplink signal copies requires that the satellite paths be time-aligned to a small fraction of the inverse of the modulation bandwidth of the signal. This is relatively simple for air interfaces such as FDMA (Frequency Division Multiple Access), where each uplink user may be assigned a narrowband channel for a long period-this scheme is referred to Single Channel Per Carrier (SCPC). Multi-satellite delay equalization is also relatively simple for DS-CDMA (Direct Sequence Code Division Multiple Access). Here, although the uplink bandwidth may be relatively large compared to the user's information bandwidth, the spread spectrum gain enables the receiver to identify the time of arrival (ToA) of the signal with high accuracy, and hence equalize the path delays.

In contrast, OFDMA-probably the most popular air interface today for digital communications-creates certain obstacles to time alignment for multi-satellite diversity. OFDMA combines TDMA and FDMA to create a time-frequency matrix of resource elements which can be independently assigned to a plurality of users, while guaranteeing adequate isolation between the users' signals. Because TDMA is an essential part of OFDMA, it inherits TDMA's need for incorporating “Timing Advance (TA)” in the transmission of the uplink signals. The orthogonality of TDMA channels depends on the uplink signals arriving at the satellite base station (S-BS) receiver within precise time slots. As different users' signals may originate at different points in a satellite beam, they will have different path delays, which must be equalized by UE-specific TA's implemented in the user equipment (UE). Thereby, when the diverse UE signals arrive at the S-BS, they land within their designated TDMA time slots. Methods of implementing such TA for a single satellite path are known in the prior art (See, e.g., U.S. Pat. No. 11,632,168 B2 to Zheng, et al.)

However, where there is a plurality of satellite paths with diverse path geometries, it is not possible (for a given UE) to find a single TA value that will be optimum for all satellite paths. This makes it challenging to implement multi-satellite diversity combining when the air interface is OFDMA.

To address, among other things, these problems, systems and methods are provided herein for combining copies of uplink signals by equalizing path delays for each user equipment before diversity combining in a base station. Using such embodiments, copies of UE uplink signals received by diverse satellite paths may be combined with copies of UE uplink signals received by primary satellite paths to improve overall reception of the UE uplink signal.

According to some embodiments, the UE is aware of its geolocation and transmits its location to the satellite base station (S-BS) as a part of the initial registration protocol. This enables the S-BS to acquire complete knowledge of the geometries of all satellite paths. In one example, M satellites receive uplink signals from N UEs in a beam. It is assumed that all UEs camp on the downlink, broadcast control channel (BCH) of a primary satellite. The uplink signals received on this path are assumed to be fully orthogonal in time and frequency. The signals from the other (M-1) paths are added to the first path to after appropriate, bipolar delays are added to each path, followed by pre-detection diversity combining.

The bipolar delays may be estimated by calculating propagation delays based on distances derived from the known geometries of the satellite paths. The S-BS may equalize the delays of the of the M satellite paths by adding bipolar delays to each path within its receive subsystem. Thereafter, it implements a diversity combining algorithm to linearly add the M raw signals. For example, the raw signals may be at zero-IF complex baseband, and may be optimally combined with the Maximal Ratio Combing (MRC) algorithm.

According to other embodiments, the S-BS does not use a priori knowledge of satellite or UE locations. Instead, it works exclusively by processing the composite signals received from N UEs via the M satellite paths. In such embodiments, the (M-1) relative path delays are determined by cross-correlating the composite signals from N UEs on each diverse satellite path with the composite signals received on the primary satellite path. As noted, the signals on the primary path are already orthogonal. The UE signals received on diverse paths may not be orthogonal. However, because the signals from the same UE add coherently, and the signals from different UEs add incoherently, the process of cross-correlation is still able to identify both the number of active UEs and their relative path delays as compared to the primary satellite path. Following equalization of the relative path delays, the S-BS can perform pre-detection MRC combining of all paths for each UE.

In some aspects, the techniques described herein relate to a satellite base station including: a satellite transceiver configured to communicate with a primary satellite and a diversity satellite using an orthogonal frequency division multiple access (OFDMA) communication protocol, a memory, and an electronic processor communicatively connected to the memory and the satellite transceiver, the electronic processor configured to: receive a first signal from the primary satellite, the first signal including a plurality of raw signals from a first user equipment camped on a downlink of the primary satellite; receive a second signal from the diversity satellite, the second signal including at least one of the plurality of raw signals from the first user equipment; store, in a signal sample memory, a copy of the first signal and a copy of the second signal; estimate a bipolar delay for the user equipment; synchronize the copy of the first signal and the copy of the second signal by applying the bipolar delay to the copy of the second signal; and combine the synchronized copies of the first and second signals to generate a plurality of synchronized raw signals for the first user equipment.

In some aspects, the techniques described herein relate to a method for combining uplink signals from diversity satellites operating with an orthogonal frequency division multiple access (OFDMA) communication protocol, the method including: receiving a first signal from a primary satellite, the first signal including a plurality of raw signals from a first user equipment camped on a downlink of the primary satellite; receiving a second signal from the diversity satellite, the second signal including at least one of the plurality of raw signals from the first user equipment; storing a copy of the first signal and a copy of the second signal; estimating a bipolar delay for the user equipment; synchronizing the copy of the first signal and the copy of the second signal by applying the bipolar delay to the copy of the second signal; combining the synchronized copies of the first and second signals to generate a plurality of synchronized raw signals for the first user equipment; and demodulating the plurality of synchronized raw signals for the first user equipment.

Each of the above-mentioned embodiments will be discussed in more detail below, starting with example system and device architectures of the system in which the embodiments may be practiced, followed by an illustration of processing blocks for achieving an improved technical method, device, and system for reliable lockdown communication in wireless electronic locks.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (Saas), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the detailed description below, with reference to the figures.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram that illustrates a satellite wireless communication system according to some examples.

FIG. 2 is a diagram that illustrates aspects of the operation of the satellite wireless communication system of FIG. 1.

FIG. 3 is a block diagram that illustrates an earth-based satellite base station, according to some examples.

FIG. 4 schematically illustrates a system for combining diverse satellite signals for UEs in the satellite wireless communication system of FIG. 1.

FIG. 5 is a diagram that illustrates aspects of the operation of the satellite wireless communication system of FIG. 1.

FIG. 6 is a flowchart of a method for combining diverse satellite signals for UEs in the satellite wireless communication system of FIG. 1., according to some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before any embodiments of the present disclosure are explained in detail, it is to be understood that the present disclosure is not limited in its application to the details of construction and the arrangement of components set forth in the following description or illustrated in the following drawings. The present disclosure is capable of other embodiments and of being practiced or of being carried out in various ways.

It should also be noted that a plurality of hardware and software-based devices, as well as a plurality of different structural components may be used to implement aspects of the disclosure. In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronics-based aspects may be implemented in software (e.g., stored on non-transitory computer-readable medium) executable by one or more electronic processors (e.g., microprocessors). As such, it should be noted that a plurality of hardware and software-based devices, as well as a plurality of different structural components may be utilized to implement the disclosure. For example, “control units” and “controllers” described in the specification can include one or more processors, one or more memory modules including non-transitory computer-readable medium, one or more input/output interfaces, and various connections (e.g., a system bus) connecting the components.

For ease of description, the example systems or devices presented herein may be illustrated with a single exemplar of each of its component parts. Some examples may not describe or illustrate all components of the systems. Other example embodiments may include more or fewer of each of the illustrated components, may combine some components, or may include additional or alternative components.

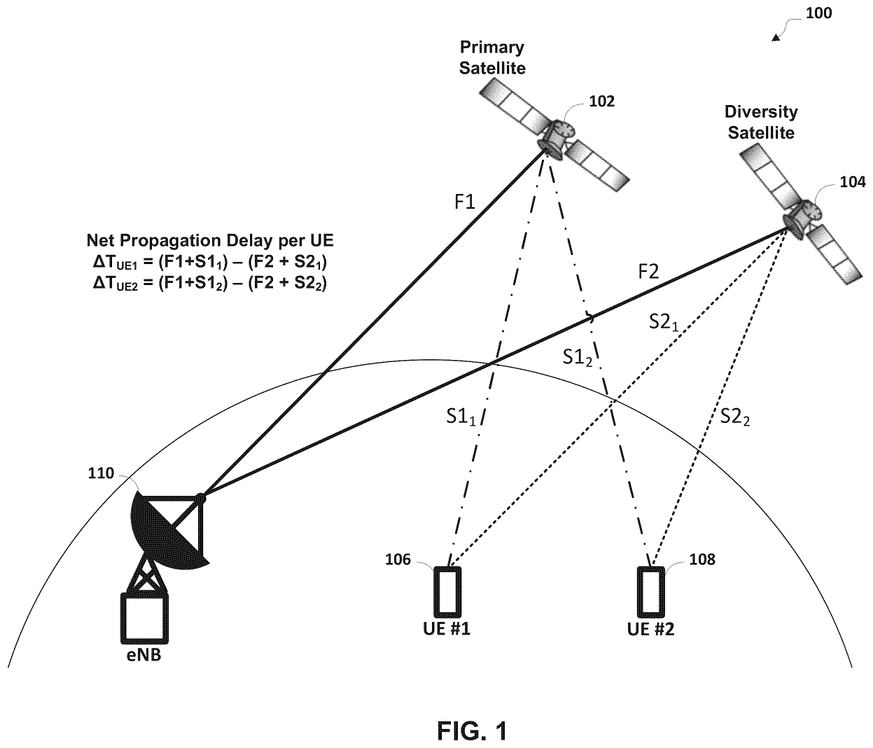

FIG. 1 is a diagram that illustrates a satellite communication system 100. In the example of FIG. 1, the terrestrial wireless communication system 100 includes a primary satellite 102, a diverse satellite 104, a first terrestrial terminal 106, a second terrestrial terminal 108, and a base station 110 that is connected to the primary satellite and the diverse satellite through feeder link F1 and F2 respectively. The first terrestrial terminal 106 and the second terrestrial terminal 108 may be referred to herein as user equipment(s) or UE(s). As illustrated in FIG. 1, the first terrestrial terminal 106 and the second terrestrial terminal 108 are in sync with the primary satellite 102 and communicate with it using service links (identified as S1₁ and S2₁ respectively). However, the uplink signals transmitted by the first terrestrial terminal 106 and the second terrestrial terminal 108 may also be received by diversity satellite 104 via diverse paths (identified as S1₂ and S2₂ respectively). The primary satellite 102 and the diverse satellite 104 communicate with the base station 110 over feeder links (identified as F1 and F2).

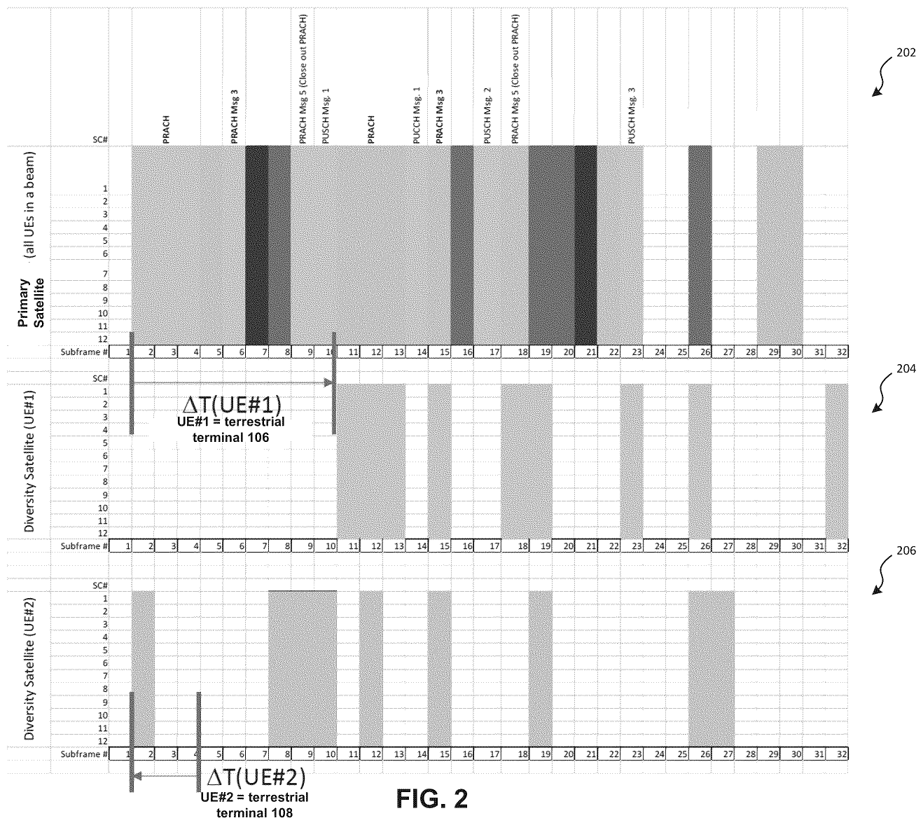

The primary satellite 102, diverse satellite 104, first terrestrial terminal 106, and second terrestrial terminal 108 may be in different locations relative to one another. This affects the propagation of the radio signals and determines when signals from the terrestrial terminals are received at the satellites, as illustrated in FIG. 2. Chart 202 of FIG. 2 illustrates signals received by the primary satellite 102 from multiple UEs, including the first terrestrial terminal 106 and the second terrestrial terminal 108. Because, in this example, the first terrestrial terminal 106 and the second terrestrial terminal 108 have established access on a spot beam of the primary satellite 102, the signals from both terminals are received in their designated time slots, as shown in chart 202. Charts 204 and 206 illustrate the respective bipolar delays for signals of the first terrestrial terminal 106 and the second terrestrial terminal 108 arriving at the diverse satellite 104.

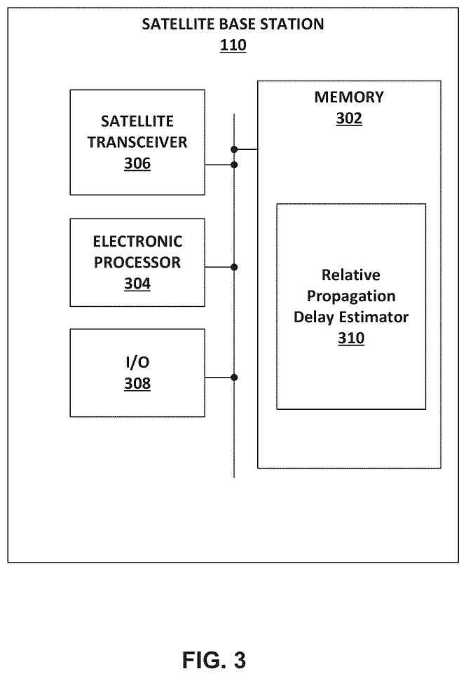

FIG. 3 is a block diagram illustrating an example of the base station 110. In the example of FIG. 3, the base station 110 includes a memory 302, an electronic processor 304 (for example, a microprocessor or another suitable electronic processing device), a satellite transceiver 306, and an input/output (I/O) interface 308.

It should be understood that, in some embodiments, the base station 110 may include fewer or additional components in configurations different from that illustrated in FIG. 3. Also, the base station 110 may perform additional functionality than the functionality described herein. As illustrated in FIG. 3, the memory 302, the electronic processor 304, the satellite transceiver, and the I/O interface 308 are electrically coupled by one or more control or data buses enabling communication between the components.

The memory 302 (also referred to as a “non-transitory computer-readable medium”) may include a program storage area (for example, read only memory (ROM)) and a data storage area (for example, random access memory (RAM), and other non-transitory, machine-readable medium). In some examples, the program storage area stores the instructions regarding the relative propagation delay estimator 310.

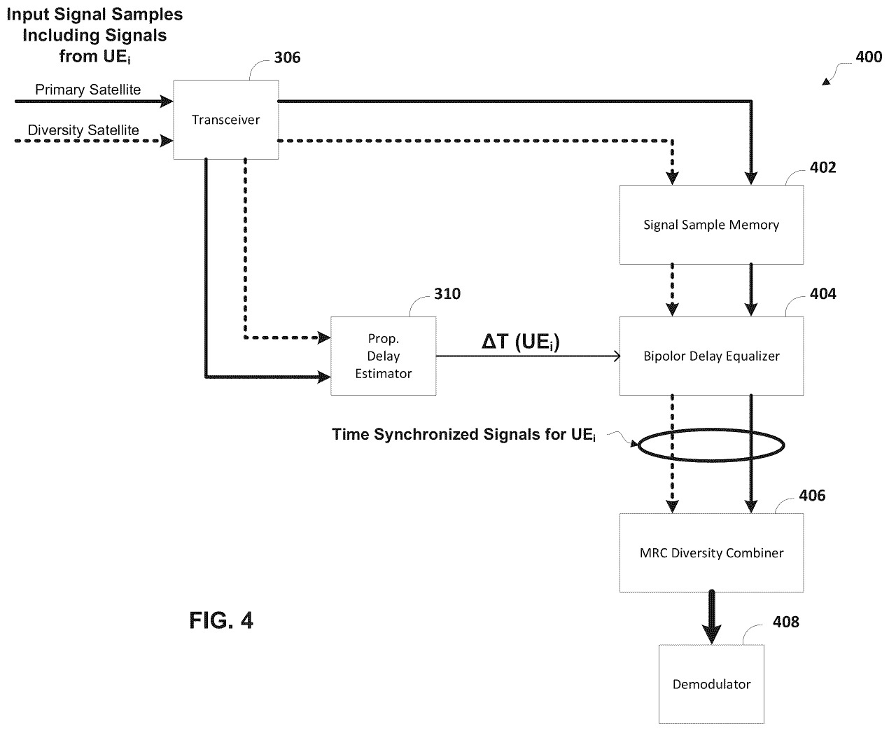

The electronic processor 304 executes machine-readable instructions stored in the memory 302. For example, the electronic processor 304 executes instructions stored in the memory 302 to perform the relative propagation delay estimation functions described below regarding combining diverse path signals. In some examples, the electronic processor 304 is a microprocessor, an application-specific integrated circuit (“ASIC”), or other suitable electronic processor. The specific methods performed by the electronic processor 304 by executing the relative propagation delay estimator 310 are explained in greater detail below with respect to FIGS. 4-6.

In some examples, the I/O interface 308 may include an Ethernet I/O interface. In other examples, the I/O interface 308 may include a wireless interface (for example, WiFi, LTE, LTE Advanced, 5G, or another suitable wireless interface). In yet other examples, the I/O interface 308 may include a navigation transceiver (for example, a GPS transceiver and/or a GNSS transceiver). In some examples, the I/O interface 308 may include a combination of an Ethernet I/O interface, a wireless interface, and/or the navigation transceiver.

FIG. 4 is a block diagram that illustrates operations of the base station 110 of FIG. 3 to overcome the differential propagation delay in the satellite communication system of FIG. 1. Some of the blocks of FIG. 4 represent hardware components and some represent software components, though all may be combinations of both (e.g., a software defined radio).

The transceiver 306 receives signals from the primary satellite 102 and the diverse satellite 104 (e.g., via the feeder links F1 and F2). For purposes of this example, a user equipment (e.g., the first terrestrial terminal 106) is assumed to be camped on a spot beam (e.g., the downlink, broadcast control channel (BCH)) of the primary satellite 102.

In this example, the primary satellite 102 and the diverse satellite 104 are bent-pipe, or non-demodulating satellites. Therefore, the ultimate source and destination of signals said to be “transmitted” and “received” by the satellite 102 are the first and second terrestrial terminals 106, 108 and the base station 110. The estimation of propagation delays is performed at the base station 110. As the propagation delays of the feeder links are common between different terminals, and the feeder link differential delays between the satellites are common for all terminals, the propagation delays of the feeder links are not addressed in this disclosure. Additionally, as explained above, the concepts and methods taught herein may also be applicable to both non-demodulating satellites and demodulating satellites.

The transceiver 306 forwards the received signals to both the signal sample memory 402 and the relative propagation delay estimator 310. The signal sample memory 402 is a memory, which buffers the received signals for further processing based on the delay estimated by the relative propagation delay estimator 310.

The relative propagation delay estimator 310 determines, for each user equipment, a ΔT (bipolar delay) relative to the primary satellite 102.

In some embodiments, the relative propagation delay estimator 310 determines the AT for each UE based on a priori knowledge of the location of the UE and the satellites, using geometric calculations to determine the bipolar delays. For example, the base station 110 may receive through the primary satellite 102, from the first terrestrial terminal 106 and the second terrestrial terminal 108, geolocation data for the first terrestrial terminal 106 and the second terrestrial terminal 108 during an initial registration protocol exchange.

In other embodiments, the relative propagation delay estimator 310 determines the ΔT for each UE using a cross-correlation method. In one example, there are N UE signals, sᵢ(t), where i is the UE index, transmitted from a given beam during an observation period T_{obs}. The N UE signals arrive at the base station via path 1 (from the primary satellite 102) and path 2 (from the diversity satellite 104), each with a net propagation delay of Δ1ᵢ, and Δ2ᵢ, respectively. The delays are represented as follows:

S1(t)=Σsᵢ(t−τ1ᵢ), for i=1 to N

S2(t)=Σsᵢ(t−τ2ᵢ), for i=1 to N

where S1(t) is the signal received by path 1, and S2(t) is the signal received by path 2. The complex cross-correlation function, y(x), of S1(t) and S2(t) is given by:

$${T}_{o b s} / 2$$

$$y ( x ) = \int S 1 ( t ) . S 2 {( t - x )}^{*} . dx$$

$$- {T}_{o b s} / 2$$

Where x is the variable delay of the cross-correlation function and ‘*’ indicates complex-conjugate.

The above can be written as N sums of the cross-correlations of all sᵢ terms of the same index, i, and (^{N}C₂−1) terms of cross-correlations of sᵢ terms of unlike indices. The first partial cross-correlations is referred to as yₗᵢₖₑ(x) and the second is referred to as yᵤₙₗᵢₖₑ(x).

$$\begin{matrix}y ( x ) = \begin{matrix}\int \{ {s}_{1} ( t - {τ1}_{1} ) + {s}_{2} ( t - {τ1}_{2} ) + … {s}_{N} ( t - {τ1}_{N} ) \} , \\ \{ {{s}_{1} ( t - {τ2}_{1} - x )}^{*} + {{s}_{2} ( t - {τ2}_{2} - x )}^{*} + … {{s}_{N} ( t - {τ2}_{N} - x )}^{*} \} . dx\end{matrix} \\ = \begin{matrix}\begin{matrix}\int {s}_{1} ( t - {τ1}_{1} ) . {{s}_{1} ( t - {τ2}_{1} - x )}^{*} . dx + \int {s}_{2} ( t - {τ1}_{2} ) . \\ \underbrace{{s}_{2} {( t - {τ2}_{2} - x )}^{*} . dx + … + \int {s}_{N} ( t - {τ1}_{N} ) . {{s}_{N} ( t - {τ2}_{N} - x )}^{*}}_{{y}_{like}} . dx\end{matrix} \\ + \underbrace{\int \sum {s}_{j} ( t - {τ1}_{j} ) . \sum {{s}_{k} ( t - {τ2}_{k} - x )}^{*} . dx , where j \neq }_{{u}_{unlike}} k\end{matrix}\end{matrix}$$

Expanding the expression for clarity:

$$\begin{matrix}y ( x ) = \int S 1 ( t ) . S 2 {( t - x )}^{*} . dx ( ignoring the limit indication for convenience ) \\ = \int \sum {s}_{i} ( t - {τ1}_{i} ) . \sum {{s}_{i} ( t - {τ2}_{i} - x )}^{*} . dx\end{matrix}$$

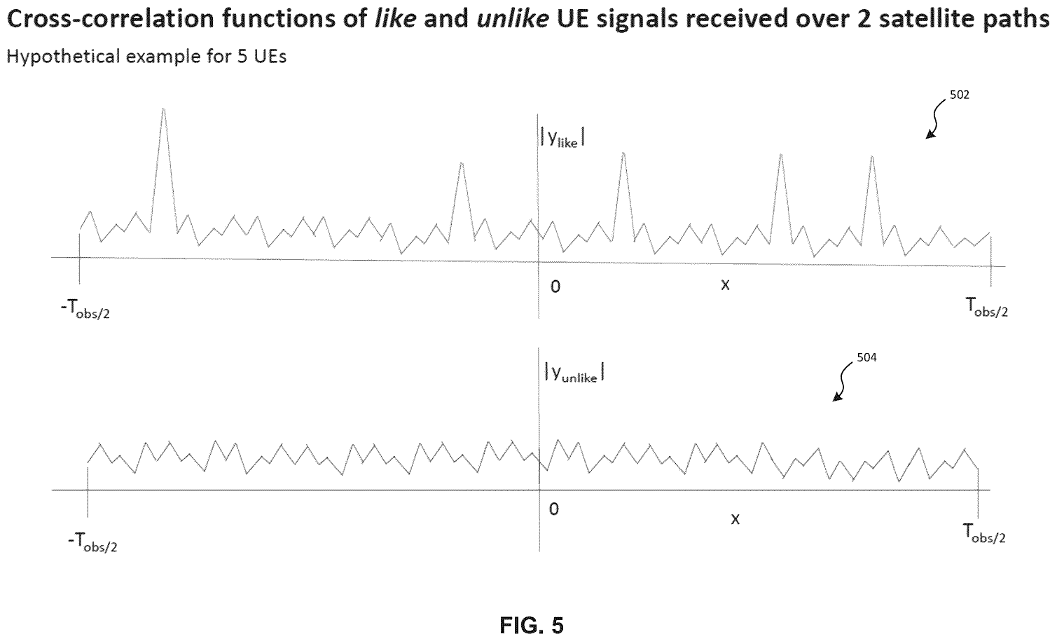

The function, |yₗᵢₖₑ(x)|, may be a time-series of N distinct delta functions as they comprise non-overlapping cross-correlations of the same UE signal over two paths. In contrast, |yᵤₙₗᵢₖₑ(x)| will be a time-series of low magnitude, random fluctuations resulting from correlations of different UE signals over two paths. Such a cross-correlation function is unlikely to rise to a high magnitude at any value of x. Examples of |yₗᵢₖₑ(x)| and |yᵤₙₗᵢₖₑ(x)| are illustrated in FIG. 5 in graphs 502 and 504, respectively.

As illustrated in graph 502, The cross-correlations will have peak magnitudes at values of xᵢ that corresponds to Δtᵢ=t1ᵢ−t2ᵢ. Contributions will occur to each cross-correlation peak of yₗᵢₖₑ(x) from all UL signals recorded during T_{obs}, which may include both Physical Random Access Channel (PRACH) and connected mode signals. Including PRACH in S1 and S2 is desirable as it adds a relatively large amount of signal energy to the correlation function.

However, because PRACH is contention based, it may also include some colliding interference from other UEs, although most are likely to be resolved in practice owing to the uniqueness of the PRACH signal. The inclusion of connected mode signals is also desirable as their contributions to the correlation function are contention-free and further enhance the correlation function.

The contributions of yᵤₙᵢₜ(x) to the net correlation function, y(x), are of much lower magnitude than the peaks of yₗᵢₖₑ(x), as shown in FIG. 5. Hence, the effect of the inter-UE collisions in S2(t) are limited to raising the noise floor of y(x) slightly but, except for very heavy channel loading, are unlikely to materially affect the ability to reliably determine the optimal Δtᵢ.

The cross-correlation method for determining the bipolar delays requires no a priori knowledge of satellite ephemeris or UE location on the part of the base station 110. Δtᵢ is determined based on the spectrum signature of the UE signals, which act as independent indicators of the differential propagation delay.

Returning to FIG. 4, the bipolar delays are fed to the bipolar delay equalizer 404, which uses the bipolar delays to synchronize the signals in the signal sample memory 402. Following relative delay equalization of the two satellite paths, the channel coefficients (complex path-gains) are determined. This is part of legacy MRC diversity processing, performed by the MRC diversity combiner 406. For example, the demodulation reference signals transmitted by each UE on each subcarrier, time-multiplexed with user-plane signals, may be used for channel estimation. The channel coefficients may be referred to as:

[H]ᵢ=[h₁, h₂]T

where i is the UE index and hⱼᵢ are the channel coefficients.

Channel estimation involves correlation of the received reference signal with a known copy of the reference signal at the receiver. If there is a substantial interference on the received reference signal, the channel coefficient will have a relatively low magnitude. This means that interference from other users, which may exist on the diversity satellite path, will automatically cause the MRC diversity combiner 406 to ascribe less weight to this input.

The complex received signals are referred to as

[s]ᵢ=[s₁ᵢ, s₂ᵢ]T

MRC diversity combining involves forming the output signal, yᵢ, by the following operation:

yᵢ=[H]ᵢ^{H}·[s]ᵢ

where [.]^{H} indicates complex conjugate transpose.

The output synchronized signals y; are then demodulated by the demodulator 408.

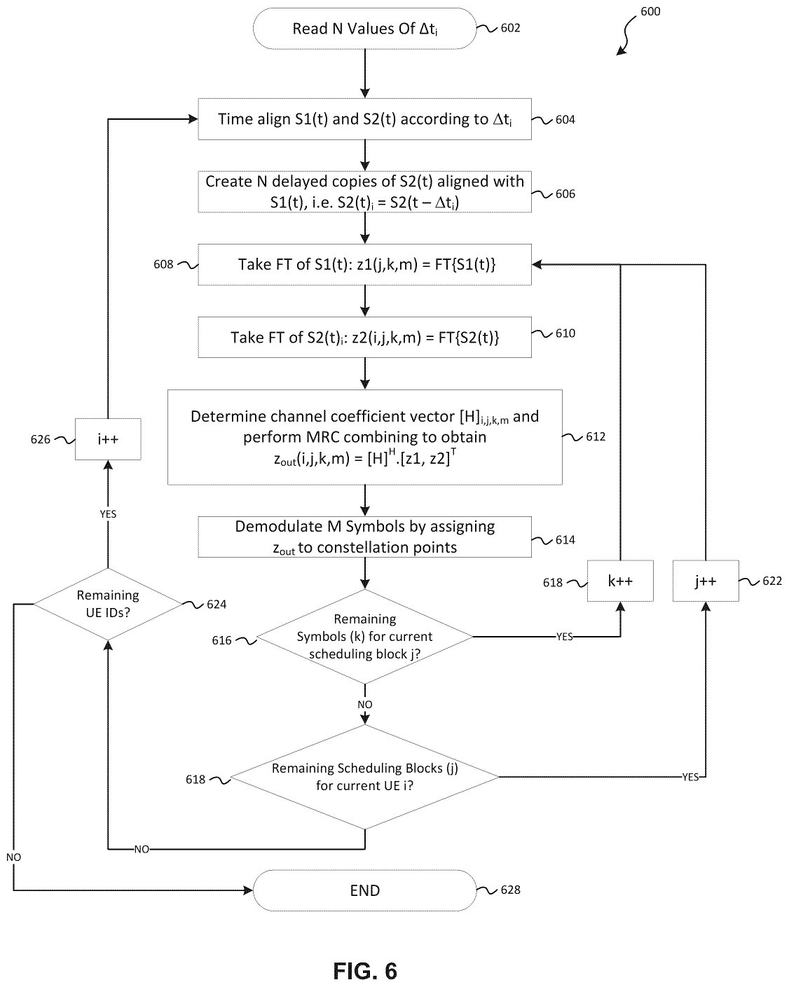

FIG. 6 is a flowchart of a method 600 for combining diverse satellite signals for UEs in the satellite wireless communication system of FIG. 1. FIG. 6 is described with reference to the base station 110 of FIG. 3 and the block diagram of FIG. 4. The method 600 is described in terms of signals received from the primary satellite 102, designated as S1(i), and the diversity satellite 104, designated as S2(i), where i ranges from 1 to Q, Q being the number of samples in T_{obs} at the sampling rate fₛ.

Before processing with the method 600, the Fourier transforms of the two signals are determined:

F1(ω), F2(ω)

Cross-correlation function y(x) is determined as follows:

y(x)−F⁻¹{F1(ω)·F2(ω)*}

where * indicates complex-conjugate and F⁻¹ indicates inverse Fourier transform.

The cross-correlation function determines a series of peaks (see FIG. 5). A peak search process determines the N largest peaks of the cross-correlation function. N is known to the base station 110 via the primary satellite 102 as the number of active UEs.

After these preliminary steps are performed, The method 600 includes reading, with the electronic processor 304, N values of Δtᵢ. As illustrated in FIG. 6, the method 600 iterates for N UEs detected to be present in the beam through cross-correlation, as described above.

At block 604, while there are still UEs, the electronic processor 304, for the current N UEs (detected to be present in the beam through cross-correlation), time aligns S1(t) and S2(t) according to Δtᵢ. At block 606, the electronic processor 304 creates N delayed copies of S2(t) aligned with S1(t) (i.e., S2(t) i=S2(t−Δtᵢ)).

The electronic processor 304 begins looping through the scheduling blocks for the UE N, where J is the number of scheduling blocks. At block 608, for current scheduling block J, the electronic processor 304 begins processing symbols for the scheduling block, where K is the number of OFDM symbols. During symbol processing, the electronic processor 304 performs Fourier transforms of an OFDM symbol vectors of signal samples received over the two satellites, wherein the vector corresponding to the diversity satellite 104 is delayed by Δtᵢ with respect to the vector corresponding to the primary satellite 102.

At block 608, the electronic processor 304 takes a Fourier transform of S1(t): z1(j,k,m)=FT{S1(t)}. At block 610, the electronic processor 304 takes a Fourier transform of S2(t): z2(j,k,m)=FT{S2(t)}, where m is the subcarrier index. The Fourier transforms are referred to as z1 and z2, from which the channel estimate [H] is determined. [H] applies to an entire slot and is derived using DM-RS pilot signals carried on one symbol in each slot. At block 613, the MRC diversity combining is performed with z1 and z2 as inputs and [H] as the weight. The electronic processor 304 determines channel coefficient vector [H]_{i.j,k,m} and performs MRC combining (e.g., with the MRC diversity combiner 406) to obtain zₒᵤₜ (i,j,k,m)=[H]H. [z1, z2]T.

At block 614, the electronic processor 304 (e.g., with the demodulator 408) demodulates M Symbols by assigning zₒᵤₜ to constellation points.

At block 616, the electronic processor 304 determines whether any symbols remain for the current scheduling block. If symbols remain, k is incremented (at block 618), and processing of symbols continues (at block 608).

If no symbols remain, the electronic processor 304 (at block 618) determines whether any scheduling blocks remain for the current UE. If scheduling blocks remain, j is incremented (at block 622), and processing of scheduling blocks continues (at block 608).

If no scheduling blocks remain, the electronic processor 304 (at block 624) determines whether any UEs remain. If UEs remain, i is incremented (at block 626), and processing continues (at block 604). If no UEs remain, the method is complete and ends at block 628.

In the examples presented herein, two satellite diversity combining was presented. It should be understood that the methods presented may be applicable to satellite diversity using three or more satellites, which would treat additional satellites as an additional path for each of the satellites. In such cases, the methods presented herein would work similarly for the additional diversity satellites. For example, where cross-correlation is used, a base station would perform the cross-correlation of each of additional paths with the primary (i.e., the first signal) path respectively to determine the Δtᵢ for a UE between the primary satellite and the additional diversity satellite for the UE.

As should be apparent from this detailed description above, the operations and functions presented are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive radiofrequency signals, and cannot automatically determine propagation delay values for radiofrequency signals, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object-oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way but may also be configured in ways that are not listed.

The terms “coupled,” “coupling,” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The following are enumerated examples of the devices, methods, and systems of the present disclosure for combining copies of uplink signals by equalizing path delays for each user equipment before diversity combining in a base station:

Example 1. A satellite base station comprising: a satellite transceiver configured to communicate with a primary satellite and a diversity satellite using an orthogonal frequency division multiple access (OFDMA) communication protocol, a memory, and an electronic processor communicatively connected to the memory and the satellite transceiver, the electronic processor configured to: receive a first signal from the primary satellite, the first signal including a plurality of raw signals from a first user equipment camped on a downlink of the primary satellite; receive a second signal from the diversity satellite, the second signal including at least one of the plurality of raw signals from the first user equipment; store, in a signal sample memory, a copy of the first signal and a copy of the second signal; estimate a bipolar delay for the user equipment; synchronize the copy of the first signal and the copy of the second signal by applying the bipolar delay to the copy of the second signal; and combine the synchronized copies of the first and second signals to generate a plurality of synchronized raw signals for the first user equipment.

Example 2. The satellite base station of example 1, wherein the electronic processor is further configured to: demodulate the plurality of synchronized raw signals for the first user equipment.

Example 3. The satellite base station of example 2, wherein the electronic processor is further configured to: combine the synchronized copies of the first and second signals by linearly adding the plurality of synchronized raw signals using a Maximal Ratio Combing (MRC) algorithm.

Example 4. The satellite base station of example 1 or example 2, wherein the electronic processor is further configured to: receive, from the user equipment, a location for the user equipment; determine a geometry for a radiofrequency path from the user equipment to the diversity satellite; and estimate the bipolar delay for the user equipment by determining a propagation delay based on distances derived from the geometry for the radiofrequency path.

Example 5. The satellite base station of example 4, wherein the electronic processor is further configured to receive, from the user equipment, the location for the user equipment during an initial registration protocol exchange.

Example 6. The satellite base station of any one of examples 1-5, wherein the electronic processor is further configured to: process the first signal and the second signal using a cross-correlation algorithm to estimate the bipolar delay for the user equipment.

Example 7. The satellite base station of example 6, wherein the electronic processor is further configured to: perform a complex cross-correlation function between the first signal (reference) and the second signal to determine a plurality of cross-correlation peaks for a plurality of user equipment; and determine the net propagation differential delay between the primary satellite and the diversity satellite for a user equipment from the cross-correlation peak location (in time) for the user equipment; and determine the bipolar delay based on a location of at least one of the plurality of cross-correlation peaks.

Example 8. The satellite base station of example 7, wherein: the first signal and the second signal are transmitted from a given beam during an observation period; and the electronic processor is further configured to perform the complex cross-correlation function by taking an integral, over an observation period, of a product of the first signal and a conjugated and time-shifted version the second signal.

Example 9. The satellite base station of example 8, wherein the electronic processor determines the bipolar delay without a priori knowledge of a position or a location of either the diversity satellite or the user equipment.

Example 10. The satellite base station of any one of examples 1-9, wherein: the plurality of raw signals in the first signal were received on an uplink of the primary satellite on a first path; and the at least one of the plurality of raw signals in the second signal were received on an uplink of the diversity satellite on a second path.

Example 11. The satellite base station of any one of examples 1-10, wherein: the satellite transceiver is further configured to communicate with a second diversity satellite using the orthogonal frequency division multiple access (OFDMA) communication protocol, and the electronic processor is further configured to: receive a third signal from the second diversity satellite, the third signal including at least one of the plurality of raw signals from the first user equipment; store, in the signal sample memory, a copy of the third signal; estimate a second bipolar delay for the user equipment relative to the second diversity satellite; synchronize the copy of the first signal, the copy of the second signal, and the copy of the third signal by applying the second bipolar delay to the copy of the third signal; and combine the synchronized copies of the first, second, and third signals to generate the plurality of synchronized raw signals for the first user equipment.

Example 12. A method for combining uplink signals from diversity satellites operating with an orthogonal frequency division multiple access (OFDMA) communication protocol, the method comprising: receiving a first signal from a primary satellite, the first signal including a plurality of raw signals from a first user equipment camped on a downlink of the primary satellite; receiving a second signal from the diversity satellite, the second signal including at least one of the plurality of raw signals from the first user equipment; storing a copy of the first signal and a copy of the second signal; estimating a bipolar delay for the user equipment; synchronizing the copy of the first signal and the copy of the second signal by applying the bipolar delay to the copy of the second signal; combining the synchronized copies of the first and second signals to generate a plurality of synchronized raw signals for the first user equipment; and demodulating the plurality of synchronized raw signals for the first user equipment.

Example 13. The method of example 12, wherein: combining the synchronized copies of the first and second signals includes linearly adding the plurality of synchronized raw signals using a Maximal Ratio Combing (MRC) algorithm.

Example 14. The method of example 12 or example 13, further comprising: receiving, from the user equipment, a location for the user equipment; determining a geometry for a radiofrequency path from the user equipment to the diversity satellite; and estimating the bipolar delay for the user equipment by determining a propagation delay based on distances derived from the geometry for the radiofrequency path.

Example 15. The method of example 14, further comprising: receiving, from the user equipment, the location for the user equipment during an initial registration protocol exchange.

Example 16. The method of any one of examples 12-15, further comprising: processing the first signal and the second signal using a cross-correlation algorithm to estimate the bipolar delay for the user equipment.

Example 17. The method of example 16, further comprising: performing a complex cross-correlation function between the first signal (reference) and the second signal to determine a plurality of cross-correlation peaks for a plurality of user equipment; and determining the net propagation differential delay between the primary satellite and the diversity satellite for a user equipment from the cross-correlation peak location (in time) for the user equipment; and determining the bipolar delay based on a location of at least one of the plurality of cross-correlation peaks.

Example 18. The method of example 17, wherein: the first signal and the second signal are transmitted from a given beam during an observation period; and performing the complex cross-correlation function includes taking an integral, over an observation period, of a product of the first signal and a conjugated and time-shifted version the second signal.

Example 19. The method of any one of examples 12-18, wherein: the plurality of raw signals in the first signal were received on an uplink of the primary satellite on a first path; and the at least one of the plurality of raw signals in the second signal were received on an uplink of the diversity satellite on a second path.

Example 20. The method of any one of examples 12-19, further comprising: receiving a third signal from the second diversity satellite, the third signal including at least one of the plurality of raw signals from the first user equipment; storing a copy of the third signal; estimating a second bipolar delay for the user equipment relative to the second diversity satellite; synchronizing the copy of the first signal, the copy of the second signal, and the copy of the third signal by applying the second bipolar delay to the copy of the third signal; and combining the synchronized copies of the first, second, and third signals to generate the plurality of synchronized raw signals for the first user equipment.

Thus, the present disclosure provides, among other things, devices, methods, and systems for combining copies of uplink signals by equalizing path delays for each user equipment before diversity combining in a base station. Various features and advantages of the present disclosure are set forth in the following claims.

What is claimed is:

1. A satellite base station comprising:
a satellite transceiver configured to communicate with a primary satellite and a diversity satellite using an orthogonal frequency division multiple access (OFDMA) communication protocol,
a memory, and
an electronic processor communicatively connected to the memory and the satellite transceiver, the electronic processor configured to:
receive a first signal from the primary satellite, the first signal including a plurality of raw signals from a first user equipment camped on a downlink of the primary satellite;
receive a second signal from the diversity satellite, the second signal including at least one of the plurality of raw signals from the first user equipment;
store, in a signal sample memory, a copy of the first signal and a copy of the second signal;
estimate a bipolar delay for the user equipment;
synchronize the copy of the first signal and the copy of the second signal by applying the bipolar delay to the copy of the second signal; and
combine the synchronized copies of the first and second signals to generate a plurality of synchronized raw signals for the first user equipment.

2. The satellite base station of claim 1, wherein the electronic processor is further configured to:
demodulate the plurality of synchronized raw signals for the first user equipment.

3. The satellite base station of claim 2, wherein the electronic processor is further configured to:
combine the synchronized copies of the first and second signals by linearly adding the plurality of synchronized raw signals using a Maximal Ratio Combing (MRC) algorithm.

4. The satellite base station of claim 1, wherein the electronic processor is further configured to:
receive, from the user equipment, a location for the user equipment;
determine a geometry for a radiofrequency path from the user equipment to the diversity satellite; and
estimate the bipolar delay for the user equipment by determining a propagation delay based on distances derived from the geometry for the radiofrequency path.

5. The satellite base station of claim 4, wherein the electronic processor is further configured to receive, from the user equipment, the location for the user equipment during an initial registration protocol exchange.

6. The satellite base station of claim 1, wherein the electronic processor is further configured to:
process the first signal and the second signal using a cross-correlation algorithm to estimate the bipolar delay for the user equipment.

7. The satellite base station of claim 6, wherein the electronic processor is further configured to:
perform a complex cross-correlation function between the first signal (reference) and the second signal to determine a plurality of cross-correlation peaks for a plurality of user equipment; and
determine the net propagation differential delay between the primary satellite and the diversity satellite for a user equipment from the cross-correlation peak location (in time) for the user equipment; and
determine the bipolar delay based on a location of at least one of the plurality of cross-correlation peaks.

8. The satellite base station of claim 7, wherein:
the first signal and the second signal are transmitted from a given beam during an observation period; and
the electronic processor is further configured to perform the complex cross-correlation function by taking an integral, over an observation period, of a product of the first signal and a conjugated and time-shifted version the second signal.

9. The satellite base station of claim 8, wherein the electronic processor determines the bipolar delay without a priori knowledge of a position or a location of either the diversity satellite or the user equipment.

10. The satellite base station of claim 1, wherein:
the plurality of raw signals in the first signal were received on an uplink of the primary satellite on a first path; and
the at least one of the plurality of raw signals in the second signal were received on an uplink of the diversity satellite on a second path.

11. The satellite base station of claim 1, wherein:
the satellite transceiver is further configured to communicate with a second diversity satellite using the orthogonal frequency division multiple access (OFDMA) communication protocol, and
the electronic processor is further configured to:
receive a third signal from the second diversity satellite, the third signal including at least one of the plurality of raw signals from the first user equipment;
store, in the signal sample memory, a copy of the third signal;
estimate a second bipolar delay for the user equipment relative to the second diversity satellite;
synchronize the copy of the first signal, the copy of the second signal, and the copy of the third signal by applying the second bipolar delay to the copy of the third signal; and
combine the synchronized copies of the first, second, and third signals to generate the plurality of synchronized raw signals for the first user equipment.

12. A method for combining uplink signals from diversity satellites operating with an orthogonal frequency division multiple access (OFDMA) communication protocol, the method comprising:
receiving a first signal from a primary satellite, the first signal including a plurality of raw signals from a first user equipment camped on a downlink of the primary satellite;
receiving a second signal from the diversity satellite, the second signal including at least one of the plurality of raw signals from the first user equipment;
storing a copy of the first signal and a copy of the second signal;
estimating a bipolar delay for the user equipment;
synchronizing the copy of the first signal and the copy of the second signal by applying the bipolar delay to the copy of the second signal;
combining the synchronized copies of the first and second signals to generate a plurality of synchronized raw signals for the first user equipment; and
demodulating the plurality of synchronized raw signals for the first user equipment.

13. The method of claim 12, wherein:
combining the synchronized copies of the first and second signals includes linearly adding the plurality of synchronized raw signals using a Maximal Ratio Combing (MRC) algorithm.

14. The method of claim 12, further comprising:
receiving, from the user equipment, a location for the user equipment;
determining a geometry for a radiofrequency path from the user equipment to the diversity satellite; and
estimating the bipolar delay for the user equipment by determining a propagation delay based on distances derived from the geometry for the radiofrequency path.

15. The method of claim 14, further comprising:
receiving, from the user equipment, the location for the user equipment during an initial registration protocol exchange.

16. The method of claim 12, further comprising:
processing the first signal and the second signal using a cross-correlation algorithm to estimate the bipolar delay for the user equipment.

17. The method of claim 16, further comprising:
performing a complex cross-correlation function between the first signal (reference) and the second signal to determine a plurality of cross-correlation peaks for a plurality of user equipment; and
determining the net propagation differential delay between the primary satellite and the diversity satellite for a user equipment from the cross-correlation peak location (in time) for the user equipment; and
determining the bipolar delay based on a location of at least one of the plurality of cross-correlation peaks.

18. The method of claim 17, wherein:
the first signal and the second signal are transmitted from a given beam during an observation period; and
performing the complex cross-correlation function includes taking an integral, over an observation period, of a product of the first signal and a conjugated and time-shifted version the second signal.

19. The method of claim 12, wherein:
the plurality of raw signals in the first signal were received on an uplink of the primary satellite on a first path; and
the at least one of the plurality of raw signals in the second signal were received on an uplink of the diversity satellite on a second path.

20. The method of claim 12, further comprising:
receiving a third signal from the second diversity satellite, the third signal including at least one of the plurality of raw signals from the first user equipment;
storing a copy of the third signal;
estimating a second bipolar delay for the user equipment relative to the second diversity satellite;
synchronizing the copy of the first signal, the copy of the second signal, and the copy of the third signal by applying the second bipolar delay to the copy of the third signal; and
combining the synchronized copies of the first, second, and third signals to generate the plurality of synchronized raw signals for the first user equipment.
